(19) United States
(12) Patent Application Publication
(10) Pub. No.: US 2019/0386824 A1
(43) Pub. Date: Dec. 19, 2019

(54) FAILOVER IN A MEDIA ACCESS CONTROL SECURITY CAPABALE DEVICE

(71) Applicant: Hewlett Packard Enterprise Development LP, Houston, TX (US)

(72) Inventors: Badrish Havaralu Rama Chandra Adiga, Bangalore (IN); Balaji Sankaran, Bangalore (IN); Venkatesh Natarajan, Bangalore (IN)

(21) Appl. No.: 16/007,594

(22) Filed: Jun. 13, 2018

(51) Int. Cl. H04L 9/08; H04L 29/06; H04L 9/32

(52) U.S. Cl. CPC H04L 9/0838; H04L 9/32; H04L 63/0876

(57) ABSTRACT

Examples disclosed herein relate to providing a failover in a MACsec capable device. In an example, a determination may be made on a Media Access Control (MAC) Security (MACsec) capable device, whether a primary management engine that manages a protocol related to MACsec standard on the MACsec capable device has failed. In response to a determination that the primary management engine has failed, a secondary management engine in the MACsec capable device may create a Connectivity Association (CA) between the MACsec capable device and a peer MACsec capable device by performing an IEEE 802.1X re-authentication with the peer MACsec capable device within MACsec Key Agreement (MKA) lifetime. The MKA lifetime may refer to a period during which no MACsec Key Agreement Protocol Data Unit (MKPDU) is received by the peer MACsec capable device from the MACsec capable device.

### BACKGROUND

Media Access Control Security (MACsec) is a technology that may provide secure communication on Ethernet links. MACsec may allow unauthorized Local Area Network (LAN) connections to be identified and excluded from communication within a network. MACsec may provide data confidentiality, data integrity and data origin authentication on Ethernet links between nodes.

### BRIEF DESCRIPTION OF THE DRAWINGS

For a better understanding of the solution, examples will now be described, purely by way of example, with reference to the accompanying drawings, in which:

FIG. 1 illustrates a block diagram of an example computing environment for providing a failover in a MACsec capable device;

FIG. 2 is a block diagram of an example MACsec capable device that provides a failover;

FIG. 3 is a flow chart of an example method of providing a failover in a MACsec capable device; and

FIG. 4 is a block diagram of is a block diagram of an example system including instructions in a machine-readable storage medium for providing a failover in a MACsec capable device.

### DETAILED DESCRIPTION

Media Access Control security (MACsec) is Institute of Electrical and Electronics Engineers (IEEE) 802 standard that specifies how to secure all or part of a LAN at the link layer. MACsec executes the encryption function in the physical layer (PHY) of an Ethernet port and offers encryption equal to that of the Ethernet port rates bi-directionally regardless of the packet size. MACsec may secure participating entities (for example, network devices) using the MACsec Key Agreement (MKA) protocol.

Enterprises are increasingly focusing on securing networks from the inside, and MACsec as layer 2 security protocol may fill this gap. To ensure the security of wired networks, it may be desirable to implement the MACsec functionality on newer generation of network devices (e.g., network switches). However, currently, the scope of IEEE 802.1X-2010 standard is limited to providing, for example, compatible authentication, authorization, and cryptographic key agreement mechanisms to support secure communication between devices. It does not address high availability features from the perspective of network devices like switches, routers etc. As used herein, “high availability” may refer to a system or component that is continuously operational for a desirably long pre-defined length of time. In the context of MACsec, it may be desirable to offer high availability in a MACsec capable device. If a system running MACsec crashes, it may be desirable for the system to recover itself in a very short span of time without affecting data traffic.

In an example, if an entity that manages a Connectivity Association (CA) goes down, all Secure Channels (SCs) and Secure Associations (SAs) in the CA may get deleted, which may affect data traffic. Thus, it is desirable that a MACsec CA is kept alive even after failover. In an example, a CA may be kept alive by exchanging keepalive MKA packets. The default transmit interval for a MKA keepalive message (MKA_TRANSMIT_INTERVAL) is two seconds. This means that once a CA is formed, the MKA packets may be exchanged between the peers participating in the CA for every two seconds to keep the session alive. And, if a MACsec peer device is not able to receive MKA packets from the crashed device for “MKA lifetime”, which may include three heartbeats of two seconds each (“MKA_TRANSMIT_INTERVAL”) i.e. 6 seconds, it may dissolve the CA by purging all SCs and SAs in the CA. For example, if “t” seconds is the time at which last MKA packet was sent out, and if the MACsec capable device crashes at (t+1.9999) seconds, this gives very little time (4.0001 seconds) for the crashed device to recover without affecting data traffic. It may be desirable for the device to perform a failover in this short span of time by creating a new CA with the MACsec peer device.

To address these issues, the present disclosure describes various examples for providing a failover in a MACsec capable device. In an example, a determination may be made on a Media Access Control (MAC) Security (MACsec) capable device, whether a primary management engine that manages a protocol related to MACsec standard on the MACsec capable device has failed. In response to a determination that the primary management engine has failed, a secondary management engine in the MACsec capable device may create a Connectivity Association (CA) between the MACsec capable device and a peer MACsec capable device by performing an IEEE 802.1X re-authentication with the peer MACsec capable device within MACsec Key Agreement (MKA) lifetime. The MKA lifetime may refer to a period during which no MACsec Key Agreement Protocol Data Unit (MKPDU) is received by the peer MACsec capable device from the MACsec capable device.

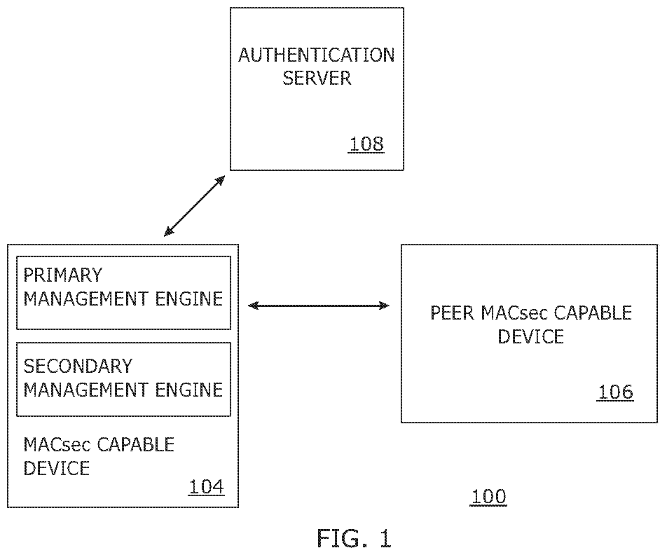

FIG. 1 illustrates a block diagram of an example computing environment 100 for providing a failover in a MACsec capable device. The computing environment 100 may include MACsec capable devices 104 and 106, and an authentication server 108. Although two MACsec capable devices are shown in FIG. 1, other examples of this disclosure may include more than two MACsec capable devices.

In an example, MACsec capable device 104 may be a network device. For example, MACsec capable device 104 may be a network switch, a network router, a virtual switch, and a virtual router. In an example, MACsec capable device 104 may be a computing device capable of executing machine-readable instructions. For example, MACsec capable device 104 may be a server, a desktop computer, a notebook computer, a tablet computer, a thin client, a mobile device, a personal digital assistant (PDA), and the like.

MACsec capable devices 104 and 106, and authentication server 108 may be communicatively coupled, for example, via a computer network. The computer network may include, for example, a wired network. The computer network may include, for example, a Local Area Network (LAN), and a Wireless Local Area Network (WLAN).

As used herein, a “MACsec capable device” may include a device that supports MACsec. As mentioned earlier, MACsec is an IEEE 802.1AE standard for authenticating and encrypting packets between two MACsec-capable devices (for example, 104 and 106). A MACsec capable device (for example, 104 and 106) may support 802.1AE encryption with MACsec Key Agreement (MKA) on downlink ports for encryption between the MACsec device and a host device.

MACsec standard may provide a MAC-layer encryption over wired networks by using out-of-band methods for encryption keying. MACsec standard may include several protocols. These may include, for example, Extensible Authentication Protocol (EAP), MACsec Key Agreement (MKA), Security Association Protocol (SAP), EAP over LAN (EAPOL), Remote Authentication Dial-In User Service (RADIUS) protocol, etc.

The MKA Protocol may manage the encryption keys used by the MACsec protocol. The MKA Protocol may allow peer discovery with confirmation of mutual authentication and sharing of MACsec secret keys to protect data exchanged by the peers.

A Connectivity Association (CA) may include a logical association between two or more MACsec participating entities (for example, 104 and 106). A secure Connectivity Association (CA) may be defined as a security relationship, established and maintained by key agreement protocols, that comprises a fully connected subset of the service access points in stations attached to a single LAN that are to be supported by MACsec. Members of a CA may be identified via a secret key called as secure Connectivity Association Key (CAK). A CAK may be identified via a secure Connectivity Association Key Name (CKN), which may be of 1 to 32 octets. Only entities with same pair of CAK and CKN may be able to form a CA.

A CA may be realized via Secure Channels (SC) between two or more MACsec entities participating in a CA. A “secure channel” may refer to a security relationship used to provide security guarantees for frames transmitted from one member of a CA to another. There may be one SC (“Transmit SC”) for secure transmission of frames from a MACsec entity to all other devices in a CA. However, there may be one or multiple SCs (“Receive SCs”) for receiving frames from other devices in a CA. Each SC may be identified via a Secure Channel Identifier (SCI), which may be a globally unique identifier for a secure channel, comprising a globally unique MAC Address and a Port Identifier. A SC remains alive until the two entities participate in the MACsec CA.

MKA provides a method for discovering MACsec peers and negotiating the security keys needed to secure a link. Two methods may be utilized to derive the MACsec encryption keys: manual pre-shared keys or Extensible Authentication Protocol (EAP). When the pre-shared keys method is used, the pre-shared key is the connectivity association key (CAK). The root key in the MACsec Key Agreement key hierarchy is the Connectivity Association Key (CAK), and is identified by a CAK Name (CKN).

In the EAP method, MKA and MACsec may be implemented after successful authentication using the 802.1X Extensible Authentication Protocol (EAP) framework. The EAP framework implements MKA as a newly defined EAP-over-LAN (EAPOL) packet. Entering the EAP session ID generates a secure CKN. The packet body in an EAPOL Protocol Data Unit (PDU) is referred to as a MACsec Key Agreement PDU (MKPDU).

SAs (Secure Associations) are rolling sessions over a SC wherein each SA may be valid for a fixed number of packets. Each SA created may be identified by a SC Identifier (SCI) concatenated with an Association Number (AN). A “secure association” may be defined as a security relationship that provides security guarantees for frames transmitted from one member of a CA to the others. Each SA is supported by a single secret key (for example, SAK) or a single set of keys. Thus, a SAK is a secret key used by an SA. A SAK may be valid till a pre-defined number of packets (e.g., 2³²) are exchanged between two entities on a SC, before rolling over for a new SA with a new SAK. Once the number of packets exchanged between two entities on an SC reaches a pre-defined threshold (e.g., 2²⁰), a “SAK rotation” is initiated. A new SA may be formed with new SAK and a timer may be started for three seconds. Upon expiry of three seconds, the old SA may be purged. Thus, after SAK rotation, there may be two SAs for three seconds of time. During this period, a MACsec PHY is expected to decrypt received MACsec frames encrypted by any of the 2 SAKs.

SAK may be used to provide data confidentiality by encrypting/decrypting a packet. The SAK may be exchanged between the MACsec entities over the MACsec Key Agreement (MKA) protocol.

The MKA protocol may be used to select one of the two participants on the point-to-point link as Key Server. The Key Server then creates a randomized encryption key (SAK) that is shared in a secure manner with the other participant. The Key Server may continue to periodically (until a packet number limit is reached) create and share a new randomly generated SAK over the point-to-point link as long as MACsec secure connectivity is maintained.

MKA and MACsec may be implemented after successful authentication using the 802.1X Extensible Authentication Protocol (EAP) framework. In an example, dynamic or derived secure association key (SAK) security mode may be used to enable MACsec between MACsec capable device 104 and peer MACsec capable device 106. In this mode, MACsec entities first authenticate each other by establishing 802.1X EAP-TLS session and a MSK (Master Session Key) generated out of successful authentication may be used to derive the CAK and CKN. 802.1X authentication or (“re-authentication”) involves three entities: a supplicant, an authenticator, and an authentication server. The supplicant is an entity that wants to get authenticated and submits credentials for authentication. In an example, peer MACsec capable device 106 may act as a supplicant. The authenticator is a network device (e.g., a switch) that aids in the authentication process by providing the supplicant's credentials to an authentication server (e.g., 108). In an example, MACsec capable device 104 may act as an authenticator. The authentication server (e.g. 108) provides an authentication service to an authenticator by validating the supplicant's credentials.

Authentication server 108 may use Extensible Authentication Protocol-Transport Layer Security (EAP-TLS) in order to support MACsec. EAP-TLS is a certificate based mutual authentication protocol with the support for key derivation. The participating entities authenticate each other and upon successful authentication, the authentication server 118 and the supplicant derive a common MSK. The MSK may be passed from authentication server 108 to MACsec capable device 104 (e.g., a switch) and from authentication server 108 to peer MACsec capable device 106 (e.g., a host device) in independent authentication transactions. The master key is then passed between MACsec capable device and the peer MACsec capable device to create a MACsec connection by deriving CAK and CKN. After every successful 802.1X re-authentication, a new pair of MSK and session-ID may be generated, a new CA is formed with a new pair of derived CAK and CKN.

In some examples, MACsec capable device 104 may include a primary management engine 112 and a secondary management engine 114.

Engines 112 and 114 may include any combination of hardware and programming to implement the functionalities of the engines described herein. In examples described herein, such combinations of hardware and software may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of MACsec capable device (for example, 104). In some examples, the at least one machine-readable storage medium may store instructions that, when executed by the at least one processing resource, at least partially implement some or all engines of the computing device. In such examples, MACsec capable device (for example, 104) may include the at least one machine-readable storage medium storing the instructions and the at least one processing resource to execute the instructions.

In an example, primary management engine 112 may manage (e.g., run) a protocol (for example, MKA) related to MACsec standard in MACsec capable device 104. The MACsec standard may include several protocols. These protocols may include, for example, Extensible Authentication Protocol (EAP), MACsec Key Agreement (MKA), Security Association Protocol (SAP), EAP over LAN (EAPOL), Remote Authentication Dial-In User Service (RADIUS) protocol, etc.

In an example, when a link is first established between MACsec capable devices 104 and 106, they become peers. Mutual peer authentication may take place after a successful authentication using the 802.1X Extensible Authentication Protocol (EAP) framework, as described earlier. On successful peer authentication, a connectivity association may be formed between the peers, and a secure CKN may be exchanged between MACsec capable devices 104 and 106 to authenticate each participant, and the MKA protocol enables and maintains MACsec on the link. A security association may be formed between peer MACsec capable devices 104 and 106. The MKA protocol may be used to select MACsec capable device on the point-to-point link as Key Server.

The Key Server may create a randomized encryption key (SAK) that is shared in a secure manner with the other participant (i.e. peer MACsec capable device). The Key Server may continue to periodically (until a packet number (PN) limit is reached) create and share a new randomly generated SAK over the point-to-point link for as long as MACsec secure connectivity is maintained. A packet number (PN) may refer to a monotonically increasing value used to uniquely identify a MACsec frame in the sequence of frames transmitted using an SA.

In an example, secondary management engine 114 on MACsec capable device may determine whether the primary management engine 112 that manages a protocol related to MACsec standard on the MACsec capable device 104 has failed. In an example, secondary management engine 114 may represent a failover component for primary management engine 112. Secondary management engine 114 may be configured to run a protocol (for example, MKA) related to MACsec standard in MACsec capable device 104 in the event primary management engine 112 becomes unavailable (for example, in case of failure). In an example, primary management engine 112 and secondary management engine 114 may exchange keepalive messages at periodic intervals. If more than a pre-defined number of keepalive messages go unanswered, secondary management engine 114 may determine that primary management engine 112 has failed. Secondary management engine 114 may determine that primary management engine 112 has failed in case secondary management engine 114 does not receive a keepalive message from primary management engine 112 in a pre-defined time period.

Since the primary management engine 112 manages a protocol related to MACsec standard on the MACsec capable, its failure may lead to a failure of a Connectivity Association (CA) between MACsec capable device 104 and peer MACsec capable device 106. If the CA goes down, Secure Channels (SCs) and Secure Associations (SAs) in the CA may get deleted, which may affect data traffic. Thus, it is desirable that a MACsec CA is kept alive even after failover. In an example, a CA may be kept alive by exchanging keepalive MKA packets. The default transmit interval (MKA_TRANSMIT_INTERVAL) for a MKA keepalive message may be two seconds. This means that once a CA is formed, the MKA packets may be exchanged between the peers participating in the CA for every two seconds to keep the session alive. And, if a MACsec peer device (e.g., 106) is not able to receive MKA packets from the crashed device for “MKA lifetime”, which may be defined as a period during which no MACsec Key Agreement Protocol (MKPDU) is received by the peer MACsec capable device 106 from the MACsec capable device 104, it may dissolve the CA by purging all SCs and SAs in the CA.

In an example, the MKA lifetime may include sending a MKPDU to the peer MACsec capable device for a pre-defined number of times over pre-defined time intervals (“MKA_TRANSMIT_INTERVAL”). In an example, the pre-defined number of times may be three, and the pre-defined time intervals may be of two seconds each. For example, the MKA lifetime may include three heartbeats of two seconds each i.e. 6 seconds. In an example, if “t” seconds is the time at which last MKA packet was sent out by MACsec capable device 104, and if the primary management engine 112 on MACsec capable device 104 crashes at (t+1.9999) seconds, it may leave very little time (4.0001 seconds) to the crashed device to recover without affecting data traffic. In the above example, MACsec capable device 104 may perform a failover to secondary management engine 114 in this short span of time (4.0001 seconds) by creating a new CA with the peer MACsec capable device 106.

In an example, the creation of a new CA may be expedited by reducing the pre-defined time interval (MKA_TRANSMIT_INTERVAL) to less than two seconds in MACsec device 104 until the new CA is created between MACsec capable device 104 and peer MACsec capable device 106. In an example, MACsec capable device 104 may expedite the creation of a new CA by sending a response MKPDU packet to the peer MACsec capable device, in response to receiving a MKPDU packet from the peer MACsec capable device. The response MKPDU packet may be sent prior to an expiry of a time period (e.g., 2 seconds) defined for the pre-defined time periods in MKA lifetime.

In response to a determination by secondary management engine 114 that the primary management engine 112 has failed, secondary management engine 114 may create a CA between the MACsec capable device and the peer MACsec capable device 106 by performing an IEEE 802.1X re-authentication with the peer MACsec capable device 106 within the MKA lifetime. The “re-authentication” mechanism has been described earlier.

In response to a successful 802.1X EAP-TLS re-authentication, a new pair of MSK and session-ID may be generated, and hence a new CA may be formed with a new pair of derived CAK and CKN between MACsec capable device 104 and peer MACsec capable device 106. This would cause no effect on data traffic between MACsec capable device 104 and peer MACsec capable device 106. In the context of example described above, if secondary management engine 114 on MACsec capable device forms a new CA with the peer MACsec capable device 106 in 4.0001 seconds, data traffic between MACsec capable device 104 and the peer MACsec capable device 106 may not get affected.

In an example, peer MACsec capable device 106 may purge the old CA (with MACsec capable device 104) along with its SCs and SAs after MKA lifetime since it would not receive any keepalive packets corresponding to the old CA from the MACsec capable device 104. However, by this time, since a new CA is formed by secondary management engine 114, data traffic between MACsec capable device 104 and peer MACsec capable device 106 does not get affected.

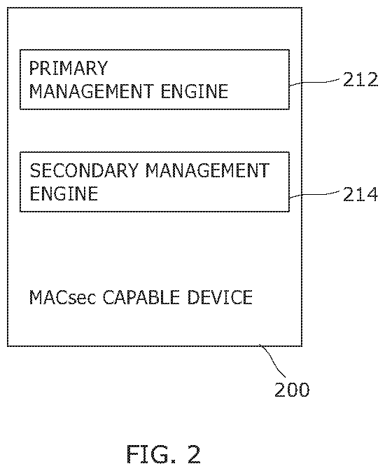

FIG. 2 is a bock diagram of an example MACsec capable device 200 for providing a failover. In an example, MACsec capable device 200 may be analogous to MACsec capable devices 104 or 106 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

In an example, MACsec capable device 200 may be a network device. For example, MACsec capable device 200 may be a network switch, a network router, a virtual switch, and a virtual router. In another example, MACsec capable device 200 may be a computing device capable of executing machine-readable instructions. For example, MACsec capable 200 device may be a server, a desktop computer, a notebook computer, a tablet computer, a thin client, a mobile device, a personal digital assistant (PDA), and the like.

In an example, MACsec capable device 200 may include a primary management engine 212 and a secondary management engine 214. In an example, primary management engine 212 and a secondary management engine 214 may perform functionalities similar to those described earlier in reference to primary management engine 112 and secondary management engine 114 of FIG. 1, respectively.

The secondary management engine 214 may act as a failover component for the primary management engine 212. In an example, primary management engine 212 may run a protocol related to MACsec standard in the MACsec capable device. In an example, secondary management engine 214 may determine whether primary management engine 212 has failed. In an example, secondary management engine 214 may determine that primary management engine 212 has failed in case secondary management engine 214 does not receive a keepalive packet from the primary management engine 212 in a pre-defined time period.

In response to a determination that the primary management engine 212 has failed, secondary management engine 214 may create a Connectivity Association (CA) between the MACsec capable device (for example, 200) and a peer MACsec capable device by performing an IEEE 802.1X re-authentication, as described earlier, with the peer MACsec capable device within MACsec Key Agreement (MKA) lifetime. The MKA lifetime may refer to a period during which no MACsec Key Agreement Protocol Data Unit (MKPDU) is received by the peer MACsec capable device from the MACsec capable device.

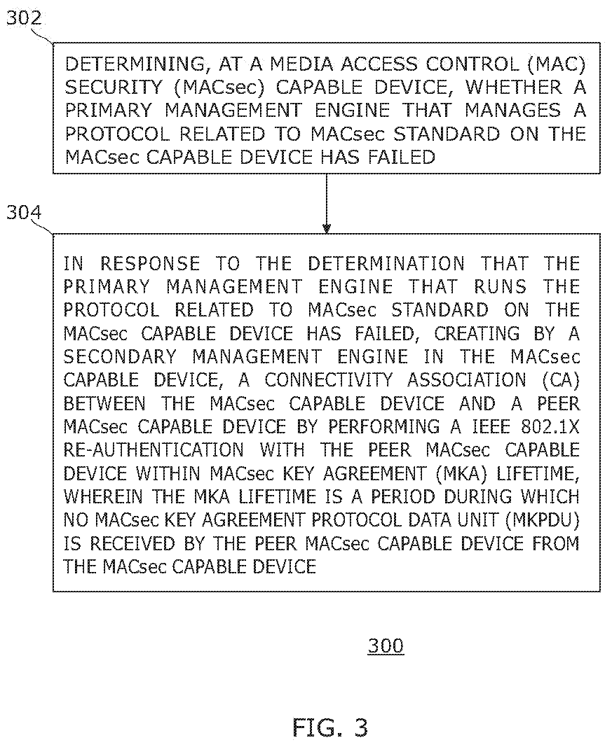

FIG. 3 is a flow chart of an example method 300 of providing a failover in a MACsec capable device. The method 300, which is described below, may be partially executed on a computing device such as MACsec capable devices 104 and 106 of FIG. 1 or 200 of FIG. 2. However, other suitable computing devices may execute method 300 as well.

At block 302, a secondary management engine in a MACsec capable device (e.g., 104) may determine whether a primary management engine in the MACsec capable device that manages a protocol related to MACsec standard on the MACsec capable device has failed.

At block 304, in response to a determination that the primary management engine that runs the protocol related to MACsec standard on the MACsec capable device has failed, the secondary management engine may create a Connectivity Association (CA) between the MACsec capable device and a peer MACsec capable device by performing an IEEE 802.1X re-authentication with the peer MACsec capable device within MACsec Key Agreement (MKA) lifetime, wherein the MKA lifetime is a period during which no MACsec Key Agreement Protocol Data Unit (MKPDU) is received by the peer MACsec capable device from the MACsec capable device

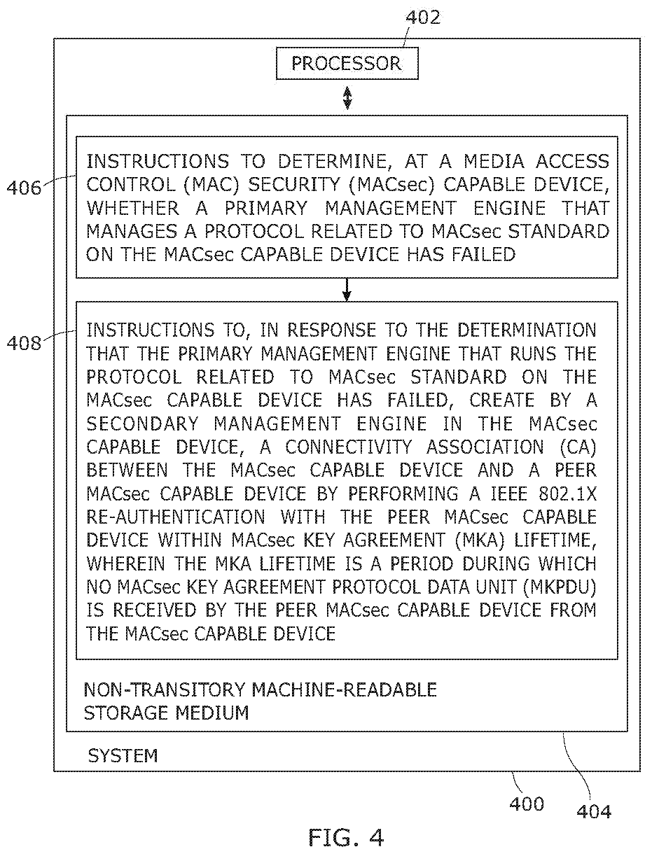

FIG. 4 is a block diagram of an example system 400 including instructions in a machine-readable storage medium for providing a failover in a MACsec capable device. System 400 includes a processor 402 and a machine-readable storage medium 404 communicatively coupled through a system bus. In an example, system 400 may be analogous to MACsec capable devices 112 and 114 of FIGS. 1, and 200 of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 404 may store instructions 406, 408, 410, and 412.

In an example, instructions 406 may be executed by processor 402 to determine, at a Media Access Control (MAC) Security (MACsec) capable device, whether a primary management engine that manages a protocol related to MACsec standard on the MACsec capable device has failed. Instructions 408 may be executed by processor 402 to, in response to the determination that the primary management engine that runs the protocol related to MACsec standard on the MACsec capable device has failed, create by a secondary management engine in the MACsec capable device, a Connectivity Association (CA) between the MACsec capable device and a peer MACsec capable device by performing an IEEE 802.1X re-authentication with the peer MACsec capable device within MACsec Key Agreement (MKA) lifetime, wherein the MKA lifetime is a period during which no MACsec Key Agreement Protocol Data Unit (MKPDU) is received by the peer MACsec capable device from the MACsec capable device.

For the purpose of simplicity of explanation, the example method of FIG. 3 is shown as executing serially, however it is to be understood and appreciated that the present and other examples are not limited by the illustrated order. The example systems of FIGS. 1, 2, and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution. All of the features disclosed in this specification (including any accompanying claims, abstract and drawings), and/or all of the stages of any method or process so disclosed, may be combined in any combination, except combinations where at least some of such features and/or stages are mutually exclusive.

1. A method comprising:
determining, at a Media Access Control (MAC) Security (MACsec) capable device, whether a primary management engine that manages a protocol related to MACsec standard on the MACsec capable device has failed; and
in response to the determination that the primary management engine that runs the protocol related to MACsec standard on the MACsec capable device has failed, creating by a secondary management engine in the MACsec capable device, a Connectivity Association (CA) between the MACsec capable device and a peer MACsec capable device by performing an IEEE 802.1X re-authentication with the peer MACsec capable device within MACsec Key Agreement (MKA) lifetime, wherein the MKA lifetime is a period during which no MACsec Key Agreement Protocol Data Unit (MKPDU) is received by the peer MACsec capable device from the MACsec capable device.

2. The method of claim 1, wherein the MKA lifetime includes sending a MKPDU to the peer MACsec capable device for a pre-defined number of times over pre-defined time intervals.

3. The method of claim 2, wherein the pre-defined number of times is three, and the pre-defined time intervals are of two seconds each.

4. The method of claim 2, further comprising:
reducing the pre-defined time intervals to less than two seconds until the CA is created between the MACsec capable device and the peer MACsec capable device.

5. The method of claim 2, further comprising:
sending, in response to receiving a MKPDU packet from the peer MACsec capable device, a response MKPDU packet prior to an expiry of a time period defined for the pre-defined time periods.

6. The method of claim 2, wherein the pre-defined number of times is three, and the pre-defined time intervals are of less than two seconds each.

7. The method of claim 1, wherein performing the IEEE 802.1X re-authentication includes performing an IEEE 802.1X authentication between the MACsec capable device and the peer MACsec capable device.

8. A MACsec capable device comprising:
a secondary management engine to:
determine whether a primary management engine that manages a protocol related to MACsec standard on the MACsec capable device has failed; and
in response to the determination that the primary management engine that runs the protocol related to MACsec standard on the MACsec capable device has failed, create a Connectivity Association (CA) between the MACsec capable device and a peer MACsec capable device by performing an IEEE 802.1X re-authentication with the peer MACsec capable device within MACsec Key Agreement (MKA) lifetime,
wherein the MKA lifetime is a period during which no MACsec Key Agreement Protocol Data Unit (MKPDU) is received by the peer MACsec capable device from the MACsec capable device.

9. The MACsec capable device of claim 8, wherein the secondary management engine to determine that the primary management engine has failed in case the secondary management engine does not receive a keepalive message from the primary management engine in a pre-defined time period.

10. The MACsec capable device of claim 8, wherein the MKA lifetime is six seconds.

11. The MACsec capable device of claim 8, wherein the secondary management engine is a failover component for the primary management engine.

12. The MACsec capable device of claim 8, wherein the protocol related to MACsec standard includes Extensible Authentication Protocol (EAP).

13. The MACsec capable device of claim 8, wherein the MACsec capable device includes one of a network switch or a router.

14. The MACsec capable device of claim 8, wherein the peer MACsec capable device is a client computer system.

15. The MACsec capable device of claim 8, wherein the protocol related to MACsec standard includes MACsec Key Agreement (MKA).

16. A non-transitory machine-readable storage medium comprising instructions, the instructions executable by a processor to:
determine, at a Media Access Control (MAC) Security (MACsec) capable device, whether a primary management engine that manages a protocol related to MACsec standard on the MACsec capable device has failed; and
in response to the determination that the primary management engine that runs the protocol related to MACsec standard on the MACsec capable device has failed, create by a secondary management engine in the MACsec capable device, a Connectivity Association (CA) between the MACsec capable device and a peer MACsec capable device by performing an IEEE 802.1X re-authentication with the peer MACsec capable device within MACsec Key Agreement (MKA) lifetime,
wherein the MKA lifetime is a period during which no MACsec Key Agreement Protocol Data Unit (MKPDU) is received by the peer MACsec capable device from the MACsec capable device.

17. The storage medium of claim 16, wherein the protocol includes EAP over LAN (EAPoL).

18. The storage medium of claim 16, wherein the IEEE 802.1X re-authentication includes Extensible Authentication Protocol-Transport Layer Security (EAP-TLS) re-authentication.

19. The storage medium of claim 16, wherein the MKA lifetime includes sending a MKPDU for a pre-defined number of times over pre-defined time intervals.

20. The storage medium of claim 16, further comprising:
sending, by the MACsec capable device, a response MKPDU packet to the peer MACsec capable device, in response to receiving a MKPDU packet from the peer MACsec capable device prior to an expiration of a pre-defined time interval included in the MKA lifetime.
